(19) United States
(12) Patent Application Publication
(10) Pub. No.: US 2006/0064398 A1
(43) Pub. Date: Mar. 23, 2006

(54) Method for the transfer of data

(75) Inventor: Karsten Koenigstein, Seefeld (DE)

Correspondence Address: SHUMAKER & SIEFFERT, P. A., 8425 SEASONS PARKWAY, SUITE 105, ST. PAUL, MN, 55125, US

(73) Assignee: egip Software AG, Starnberg (DE)

(21) Appl. No.: 11/230,115

(22) Filed: Sep. 19, 2005

(30) Foreign Application Priority Data
Sep. 23, 2004 (EP) 04 022 667.2

(51) Int. Cl. G06F 17/30

(52) U.S. Cl. 707/1

(57) ABSTRACT

The method for the transfer of data which have been assigned to a user-operable, program-controlled, data-processing-technical first application, to a user-operable, program-controlled, data-processing-technical second application, comprises the following steps: defining data fields to be taken over from the first application, defining data fields to be transferred to the second application, retrieving the first application, selecting a task adapted to be run within the first application, in connection with which and/or for which the data to be transferred from the first application or from a further application preceding the first application have to be transferred, initializing the transfer of the data from the first application, temporarily storing these data, retrieving the second application, selecting a task provided for and adapted to be run within the second application, in connection with which and/or for which the data to be transferred have to be taken over, initiating the taking-over of the data, and transfer of the temporarily stored data to the second application.

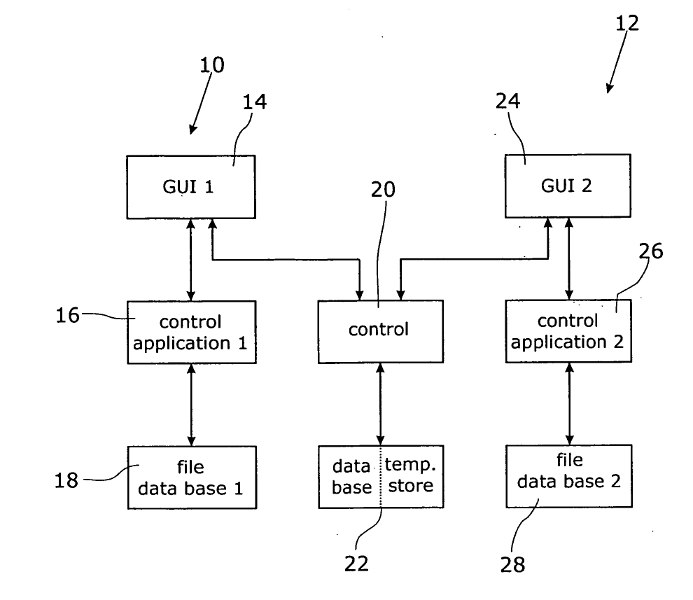

### BACKGROUND OF THE INVENTION

The present invention relates to a method for the transfer of data which have been stored/assigned for a user-operable, program-controlled, data-processing-technical first application, to a user-operable, program-controlled, data-processing-technical second application, wherein the two applications involve the access either to at least one file or data base wherein these files/data bases are not connected to each other, or the access to a common file/data base, while there exists an assignment of the data to the first application whereas no assignment exists to the second application.

In the execution of process or sub-process flows, e.g. in a credit or insurance company, it is often the case that data which have been stored in connection with a first process or sub-process can be used also for the execution of a second process or sub-process. Then, for the execution of the second process or sub-process, unless special measures are taken, the person in charge will have to once again store the per se already existing data or assign them to this second process or sub-process. To alleviate this problem, interfaces between data bases or files can be provided through corresponding software and hardware, which, however, often entails considerable expenditure.

Generally speaking, thus, the utilizing of data in further applications or uses requires a transfer of these data from a first application to a second application. Up to now, such data transfer has been mostly performed in the form of integrated uses or by means of interfaces between files/data bases. Systems of this kind (e.g. EAI systems) are operable only by EDP; accordingly, when performing adaptations, it may often take a long time until special requirements have been implemented.

It is an object of the present invention to provide a method for the transfer of data which have been assigned to a user-operable, program-controlled, data-processing-technical first application, to a user-operable, program-controlled, data-processing-technical second application, wherein the conditions for the transfer of the data are simplified and the process of the transfer is also performed in an uncomplicated manner.

### SUMMARY OF THE INVENTON

According to the instant invention, to achieve the above object, there is proposed a method for the transfer of data which have been assigned to a user-operable, program-controlled, data-processing-technical first application, to a user-operable, program-controlled, data-processing-technical second application, which method comprises the following steps:
defining data fields to be taken over from the first application,
defining data fields to be transferred to the second application,
retrieving the first application,
selecting a task adapted to be run within the first application, in connection with which and/or for which the data to be transferred from the first application or from a further application preceding the first application have to be transferred,
initializing the transfer of the data from the first application,
temporarily storing these data,
retrieving the second application,
selecting a task provided for and adapted to be run within the second application, in connection with which and/or for which the data to be transferred have to be taken over,
initiating the taking-over of the data, and
transfer of the temporarily stored data to the second application.

Thus, according to the solution proposed by the present invention, the data of an application which have to be transferred are “fetched” and temporarily stored. These temporarily stored data can then be passed over to another application. In this manner, there is safeguarded, as it were, a “non-invasive” transfer of data which guarantees an minimum expenditure in integration.

Particularly, the data are structured data. For later retrieval, these data are stored e.g. in a system data base so that, from this data base, the data can be transferred to another application or be assigned to another application.

As an example, one could consider the on-line registration e.g. with TV fee collection agencies. Within this registration process, the address data of the registering persons are polled, inter alia. It may be the case that these address data have already been stored for another online application. This could have occurred, for instance, when the same person performed his or her eBay registration. Thus, in this case, the invention would be applied under HTML. The HTML data stored under eBay can now—as initiated by the user—be temporarily stored and then, during execution, be copied into the second application, i.e. the registration with the fee collection agency.

It is not imperative that the data transfer is “visible” to the user. Instead of being performed in the foreground, the data transfer can also be performed as a “batch” in the background. Further, the data transfer will always be carried out utilizing the existing applications and business logics, respectively.

Further, the data to be transferred do not necessarily have to be assigned to the first application or be stored under the first application. It can also be contemplated that the data to be transferred come from a further application preceding the first application or from a task of the first application preceding the just executed task, or from another application.

An embodiment of the invention will be described in greater detail hereunder with reference to the accompanying drawing.

### BRIEF DESCRIPTION OF THE DRAWING

The sole FIGURE of the drawing schematically illustrates the mutual linking between individual components of various programs and data bases.

### DETAILED DESCRIPTION OF PREFERRED EMBODIMENTS OF THE INVENTION

By way of example, it is assumed that a user wishing to perform a task wants to have relevant data transferred from a first application 10 to a second application 12. For this purpose, from different areas of a user interface of the first application 10, data will be defined which shall be temporarily stored for transfer to the second application 12. The respective user interface (graphic user interface) 14 indicates diverse data, notably under control by a program 16 accessing a file stored in a data base 18. For instance, it can be assumed that the relevant data comprise the first and second names, the street, the post code and the city as well as the e-mail address of a member registered with eBay. After the data to be transferred have been defined, these will be stored in an intermediate store or a data base 22 as controlled by a program control unit 20.

Thereafter, the second application 12 is retrieved. The second application 12 can be e.g. the on-line registration with the local energy providers, a TV fee collection agency or other institutions. Also in this retrieval process, personal data of the registering person are polled in a user interface 24. This user interface 24 is controlled through a program 26 and arranged to cooperate with files of a further data base 28. In other words, the two applications 10 and 12 are applications which are not linked to each other and which now, due to the inventive “fetching” and “copying” of data, can be “data-linked” to each other by the user in an extremely convenient manner.

While an example of the invention has been described above with reference to an HTML application, the invention is likewise useful for other applications such as e.g. 3270 and the like.

Although the invention has been described and illustrated with reference to a specific illustrative embodiment thereof, it is not intended that the invention be limited to this illustrative embodiment. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

1. A method for the transfer of data which have been assigned to a user-operable, program-controlled, data-processing-technical first application, to a user-operable, program-controlled, data-processing-technical second application, which method comprises the following steps:
defining data fields to be taken over from the first application,
defining data fields to be transferred to the second application,
retrieving the first application,
selecting a task adapted to be run within the first application, in connection with which and/or for which the data to be transferred from the first application or from a further application preceding the first application have to be transferred,
initializing the transfer of the data from the first application,
temporarily storing these data,
retrieving the second application,
selecting a task provided for and adapted to be run within the second application, in connection with which and/or for which the data to be transferred have to be taken over,
initiating the taking-over of the data, and
transfer of the temporarily stored data to the second application.
